(19) United States
(12) Patent Application Publication
(10) Pub. No.: US 2006/0028070 A1
(43) Pub. Date: Feb. 9, 2006

(54) High force density linear electric motor

(75) Inventor: Funda Sahin Nomaler, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/531,976

(22) PCT Filed: Sep. 22, 2003
(86) PCT No.: PCT/IB03/04226

§ 371 Date: Apr. 20, 2005

(30) Foreign Application Priority Data
Oct. 25, 2002 (EP) 02079461.6

(51) Int. Cl. H02K 41/00

(52) U.S. Cl. 310/12

(57) ABSTRACT

Linear electric motor or actuator comprising a movable part (21) consisting of a soft-magnetic core (22) which supports a set of electrically conductive turns (25), which movable part is slidably supported by a rail (26) which is provided with at least one set of permanent magnets (27, 30, 31) extending in longitudinal direction along the core's periphery. The magnets (27, 30, 31) produce a magnetic field that cooperates with the set of turns (27, 30, 31) via an air-gap. The soft-magnetic core (22) of the movable part (21) is made of soft-magnetic composite material. The electrically conductive turns (25) are wound around the periphery of the core (21) substantially perpendicularly to the centerline thereof, and at least two sets of magnets (27, 30, 31) are arranged along its periphery such that the at least two sets of magnets (27, 30, 31) are arranged at different angles to the core (22).

The present invention relates to a linear electric motor or actuator comprising a movable part consisting of a soft-magnetic core which supports a set of electrically conductive turns, which movable part is slidably supported, generally with the use of air-bearings, by a rail structure which is provided with at least one set of permanent magnets distributed in longitudinal direction along the core's periphery, which magnets produce magnetic fields that cooperate with the set of turns via an air gap.

Linear electric motors of the type described above have long been known and are extensively used for various purposes, especially as actuators. The movable part of such a known motor is provided with a core consisting of a stack of laminated soft-magnetic steel plates. The stacked configuration of the steel plates on the one hand reduces the electrical losses in the core but, on the other hand, provides the core with only a 2D flux carrying capability, i.e. only flux conduction in the thin plates and not in the transverse direction.

Although these electric motors function very well and have been extensively used for a considerable time, they have the disadvantage that they are rather heavy and bulky in relation to the force they are able to provide owing to their core construction.

It is an object of the present invention to provide a linear electric motor which is lighter and smaller and has a reduced volume compared with the known standard linear motors.

In order to achieve this object, the linear electric motor or actuator according to the invention is characterized in that the soft-magnetic core of the movable part is made of soft-magnetic composite material, and the electrically conductive turns are wound around the periphery of the core substantially perpendicularly to the centerline of the core, and at least two sets of magnets are provided on the rail in its longitudinal direction such that the at least two sets of magnets are arranged at different angles to the core.

It has to be noted here that the soft-magnetic composite material used for the core of the inventive linear motor or actuator has been known for a number of years and has been disclosed, for example, in “Permanent-Magnet Machines with Powdered Iron Cores and Prepressed Windings” by Alan G. Jack; Barrie C. Mecrow; Philip G. Dickinson; Dawn Stephenson; James S. Burdess; Neville Fawcett and J. T. Evans in EEEE Transactions on Industrial Applications, Vol. 36, No. 4, July/August 2000.

Although the use of soft-magnet composite materials in permanent-magnet machines has been described in this publication, nothing has been disclosed about the constructional advantages such materials could have for linear motors or actuators, neither has a particular configuration of linear motors using soft-magnetic composite materials been suggested.

The idea on which the present invention is based proposes to make use of the three-dimensional {3D} flux carrying capability of the soft-magnetic composite material in such a way that the amount of force-producing surface area of the linear motor is increased without a further increase in the amount of copper used for the turns and consequently without increase in the losses produced in the machine.

According to the invention, the core may have an elongate shape with a cross-sectional shape in the form of a square, a rectangle, a triangle, or a circle. The cooperating rail should then, of course, have a corresponding cross-sectional shape, and the sets of permanent magnets are arranged on that rail such that they surround the core and the turns at least partly. In that way the magnetic fields of the permanent magnets are directed at different angles to the core so that the surface of interaction between the magnets and the windings is substantially increased. This inventive arrangement of the magnets around the core is made possible by the 3D-flux carrying capability of the soft-magnetic composite core material.

A further embodiment of the linear electric motor/actuator according to the invention is characterized in that the rail is provided with cooling means which extend in its longitudinal direction and are in heat-exchanging contact with the core and turns over part of their periphery.

According to a further embodiment of the inventive motor, it is also possible to provide the core with internal cooling channels. In that case even more of the outer surface of the core and turns structure remains available for cooperation with sets of permanent magnets.

According to another embodiment of the motor according to the invention, the core is provided with circumferential slots in which the turns are located.

Further advantages and characteristics of the present invention will be explained in the following detailed description of the invention with reference to the accompanying drawings, in which:

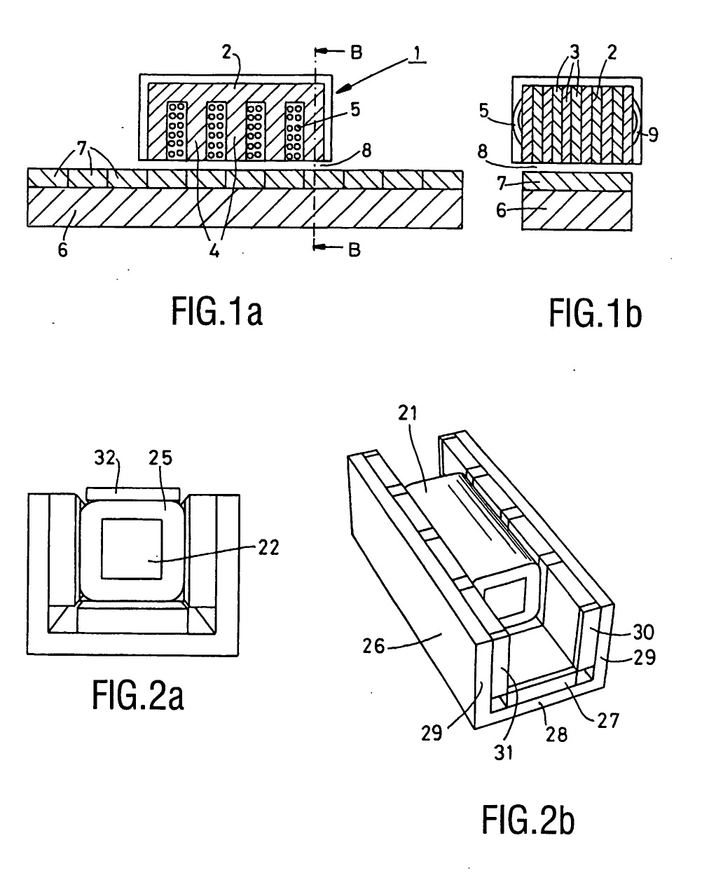

FIGS. 1a and 1b are a diagrammatic side elevation and cross-section, respectively, of a conventional linear electric motor, not true to scale.

FIGS. 2a and 2b are a diagrammatic side and front elevation, respectively, of a linear electric motor according to the present invention, not true to scale.

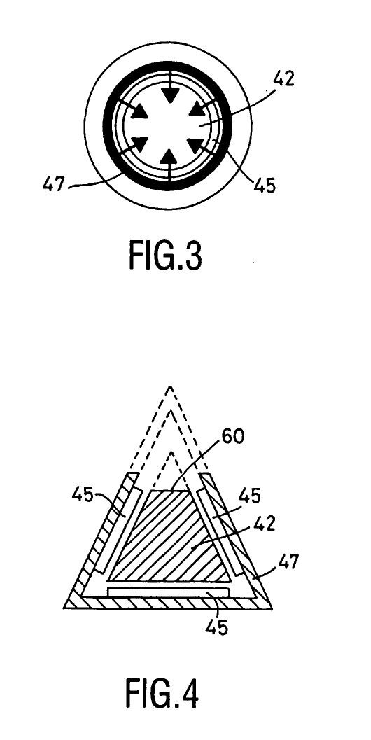

FIGS. 3 and 4 diagrammatically show the sectional shape of the moving part of a linear electric motor according to the present invention, with a circular and a triangular shape, respectively.

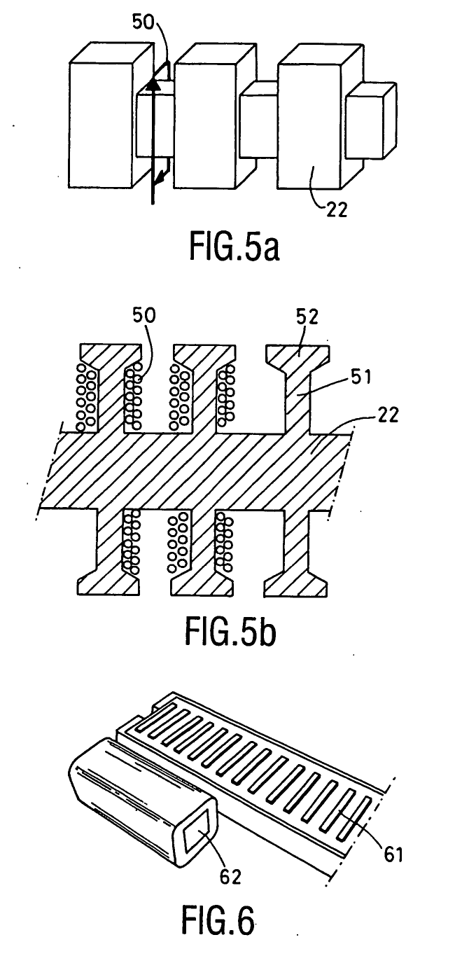

FIG. 5 shows the core of a linear electric motor according to the present invention, which is provided with circumferential slots in which the turns can be placed.

FIG. 6 shows the moving parts of a conventional motor and of a linear 20 motor according to the invention, both motors providing similar power.

FIGS. 1a and 1b show a conventional linear electric motor with a moving part 1 consisting of a core 2 comprising a stack of laminated steel plates 3. The plates 3 are provided with teeth 4 around which turns 5 of electrically conductive wires are placed. The movable part 1 is slidable in a rail 6 in which permanent magnets 7 are accommodated which cooperate with the turns 5, via an air-gap.

A problem with such a conventional construction is in the fact that the laminated core is only able to carry magnetic flux along the steel plates and not in a transverse direction, which constitutes a severe limitation for the area of the force-producing surface. A further problem is that it is very difficult from a constructional point of view to cool the moving part efficiently in order to achieve an acceptable working temperature. Also, the end turns 9 in this embodiment do not contribute to the force production.

FIGS. 2a and 2b show a similar linear electric motor which also comprises a moving part 21 and a rail 26, but now the movable part consists of a core 22 made-of a soft-magnetic composite material and the turns 25 are wound directly around the core 22 substantially perpendicularly to the centerline of the core. The rail 26 has a U-shaped cross-section with a bottom wall 28 and two side walls 29, both the bottom wall and the two side walls each carry a set of permanent magnets 27, 30 and 31 which cooperate with the windings 25 on the core 22 via their associated air-gaps. It will be clear that in this way all three of the sides of the core contribute to the force generation of the motor. If desired, this can still be increased by closing the top side of the rail and by positioning a set of permanent magnets also on this side, so that all sides of the moving part and the rail serve as a force-producing surface.

The arrangement of two, three, or even four sets of permanent magnets along the respective sides of the movable part is made possible by the fact that the soft-magnetic material used for the core 22 has 3D-flux carrying capability. In this way the force density of the linear electric motor is increased, compared with a conventional linear motor.

In FIG. 6, a movable part of a conventional linear electric motor has reference numeral 61, and the movable part of a linear motor according to the invention generating the same force has reference numeral 62. It will be immediately clear that the size of the moving part 62 according to the invention is about half the size of the conventional moving part. From this, it will be clear that linear electric motors according to the present invention can be much smaller and lighter than conventional motors providing the same force.

As is diagrammatically shown in FIG. 2b, the top side of the rail 26 supports a cooling channel 32 which is in good heat-exchanging contact with the moving part 21 and its core 22 and turns 25. With such a cooling channel, heat can be extracted very efficiently from the machine so that its operational temperature will be kept within acceptable limits.

Instead of using one of the sides of the movable part for heat-exchanging contact with cooling channels as in the embodiment according to FIG. 2b, it is also possible to provide the core 22 with internal cooling channels so that in such a case the upper side can also be used as a force-producing surface. The only thing to be done is to locate a permanent magnet on this side which cooperates with the turns.

Further possible embodiments of the linear electric motor according to the invention are schematically shown in FIGS. 3 and 4. In the embodiment according to FIG. 3, the transverse sectional shape is circular. This is in fact a very advantageous shape. The circular core 42 can be easily manufactured and the turns 45 can be easily wound around the circular core without sharp bends. The permanent magnets 47 are in this case rin-magnets, which may either completely surround the core 42 and turns 45, or the construction may have the shape as shown in the drawing, such that a cooling channel can be arranged in heat-exchanging contact with the core and turns on the flat top surface.

FIG. 4 schematically shows that the linear electric motor according to the invention may also have a triangular sectional shape or a partly triangular shape, in which the top part of the triangle is taken away, if so desired, so that the top surface 60 of the core can be provided with cooling elements.

Finally, FIG. 5 shows how the core 21 of soft-magnetic composite material can be provided with circumferential slots 50 in which the electrically conductive turns can be located. Although this makes the shape of the core somewhat more complicated, it reduces the size and the weight of the core and thus of the whole motor considerably. In this case the teeth 51 may also be provided with teeth-tops 52 as shown schematically in FIG. 5b in order to reduce parasitic effects.

Moving parts in linear motors tend to produce parasitic force components denoted “cogging”. In the linear motor according to the present invention it is possible to achieve zero cogging extending the soft-magnetic composite material of the core at the ends thereof in relation to the magnetic field distribution. The length of the end extensions is a function of the pole pitch of the magnet.

It will be evident from the above description that the present invention provides a linear electric motor having a number of surprising advantages over conventional linear motors. Although a limited number of configurations of the inventive motor have been described herein, it will be appreciated that many alternatives are possible within the scope of the appended claims.

1. Linear electric motor or actuator comprising a movable part (21) consisting of a soft-magnetic core 22) which supports a set of electrically conductive turns (25), which movable part (21) is slidably supported by a rail (26) which is provided with at least one set of permanent magnets (27, 30, 31), distributed in longitudinal direction along the core's periphery, which magnets produce magnetic fields that cooperate with the set of turns via an air-gap, characterized in that the soft-magnetic core (21) is made of soft-magnetic composite material, in that said electrically conductive turns (25) are wound around the periphery of the core (21) substantially perpendicularly to the central line thereof, and in that at least two sets of permanent magnets (27, 30, 31) are arranged along said periphery in longitudinal direction such that the at least two sets of magnets are arranged at different angles to said core.

2. Linear electric motor according to claim 1, characterized in that the cross-section of said core (21) of soft-magnetic composite material has a square or rectangular shape, and in that the sets of permanent magnets (27, 30, 31) are positioned along at least two, but preferably three, sides thereof.

3. Linear electric motor according to claim 1, characterized in that the cross-section of said core (42) of soft-magnetic composite material has a substantially circular shape, and said set of permanent magnets is formed by ring magnets (47) which surround a substantial portion of the circumference of the core (42) as viewed in transverse direction.

4. Linear electric motor according to claim 1, characterized in that said rail (26) is provided with cooling means (32) which extend in the longitudinal direction of the rail and are in heat-exchanging contact with said core (22) and turns (25) over part of their surface.

5. Linear electric motor according to claim 1, characterized in that said core (22) is provided with internal cooling channels.

6. Linear electric motor according to claim 1, characterized in that said core (22) is provided with circumferential slots in which said turns can be located.
